(19) United States
(12) Patent Application Publication
(10) Pub. No.: US 2026/0094338 A1
(43) Pub. Date: Apr. 2, 2026

(54) FACE AND BODY TRACKING API FOR EXTENDED REALITY (XR) MEDIA COMMUNICATION SESSIONS

(71) Applicant: QUALCOMM Incorporated, San Diego, CA (US)

(72) Inventors: Imed Bouazizi, Celina, TX (US); Nikolai Konrad Leung, San Francisco, CA (US); Thomas Stockhammer, Bergen (DE)

(21) Appl. No.: 19/339,999

(22) Filed: Sep. 25, 2025

Related U.S. Application Data
(60) Provisional application No. 63/699,931, filed on Sep. 27, 2024.

(51) Int. Cl. G06T 13/40; G02B 27/00; G06F 3/01

(52) U.S. Cl. CPC G06T 13/40; G02B 27/0093; G06F 3/011

(57) ABSTRACT

An example device for communicating augmented reality (AR) media data includes: a memory configured to store AR media data; and a processing system implemented in circuitry and configured to: invoke a function of an application programming interface (API) to determine one or more supported tracking schemes of an augmented reality (AR) runtime; send data representative of the one or more supported tracking schemes to a receiving device with which an AR media communication session is to be performed; receive, from the receiving device, data representative of a selected one of the one or more supported tracking schemes; create a tracking session with the AR runtime using the selected one of the one or more supported tracking schemes; and send an animation stream representing tracking information conforming to the selected one of the one or more supported tracking schemes to the receiving device.

This application claims the benefit of U.S. Provisional Application No. 63/699,931, filed Sep. 27, 2024, the entire contents of which are hereby incorporated by reference.

### TECHNICAL FIELD

This disclosure relates to transport of media data, in particular, extended reality media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

After media data has been encoded, the media data may be packetized for transmission or storage. The video data may be assembled into a media file conforming to any of a variety of standards, such as the International Organization for Standardization (ISO) base media file format and extensions thereof.

### SUMMARY

In general, this disclosure describes techniques for processing extended reality (XR) media data. XR media data may include any or all of augmented reality (AR) data, mixed reality (MR) data, or virtual reality (VR) data. During an XR communication session, a user may be represented by an avatar. The avatar may correspond to a base model. Throughout the XR communication session, the user may move their body, face, hands, or the like. These movements may be tracked by various devices, and this tracked data may be used to animate the base model of the avatar. For example, the avatar may be animated to match movements of the user, facial expressions of the user, poses of the user, or the like. This disclosure describes techniques that may be used to determine facial and/or body tracking schemes available for an XR communication session based on what is available from a tracking device and based on rendering/animation capabilities of a receiving device. For example, an application programming interface (API) may include functions for determining available tracking schemes and for requesting one of the tracking schemes to be used for a particular XR communication session.

In one example, a method of communicating augmented reality (AR) media data includes: invoking a function of an application programming interface (API) to determine one or more supported tracking schemes of an augmented reality (AR) runtime; sending data representative of the one or more supported tracking schemes to a receiving device with which an AR media communication session is to be performed; receiving, from the receiving device, data representative of a selected one of the one or more supported tracking schemes; creating a tracking session with the AR runtime using the selected one of the one or more supported tracking schemes; and sending an animation stream representing tracking information conforming to the selected one of the one or more supported tracking schemes to the receiving device.

In another example, a device for communicating augmented reality (AR) media data includes: a memory configured to store AR media data; and a processing system implemented in circuitry and configured to: invoke a function of an application programming interface (API) to determine one or more supported tracking schemes of an augmented reality (AR) runtime; send data representative of the one or more supported tracking schemes to a receiving device with which an AR media communication session is to be performed; receive, from the receiving device, data representative of a selected one of the one or more supported tracking schemes; create a tracking session with the AR runtime using the selected one of the one or more supported tracking schemes; and send an animation stream representing tracking information conforming to the selected one of the one or more supported tracking schemes to the receiving device.

In another example, a computer-readable storage medium has stored thereon instructions that, when executed, cause a processing system to: invoke a function of an application programming interface (API) to determine one or more supported tracking schemes of an augmented reality (AR) runtime; send data representative of the one or more supported tracking schemes to a receiving device with which an AR media communication session is to be performed; receive, from the receiving device, data representative of a selected one of the one or more supported tracking schemes; create a tracking session with the AR runtime using the selected one of the one or more supported tracking schemes; and send an animation stream representing tracking information conforming to the selected one of the one or more supported tracking schemes to the receiving device.

In another example, a method of communicating augmented reality (AR) media data includes: establishing an augmented reality (AR) media communication session with a sending device; receiving data representative of one or more supported tracking schemes from the sending device; selecting one of the one or more supported tracking schemes to be used for the AR media communication session; sending data representing the selected one of the one or more supported tracking schemes to the sending device; receiving an animation stream representing tracking data conforming to the selected one of the one or more supported tracking schemes from the sending device; and animating an avatar of a user of the sending device using the animation stream.

In another example, a device for communicating augmented reality (AR) media data includes: a memory configured to store AR media data; and a processing system implemented in circuitry and configured to: establish an augmented reality (AR) media communication session with a sending device; receive data representative of one or more supported tracking schemes from the sending device; select one of the one or more supported tracking schemes to be used for the AR media communication session; send data representing the selected one of the one or more supported tracking schemes to the sending device; receive an animation stream representing tracking data conforming to the selected one of the one or more supported tracking schemes from the sending device; and animate an avatar of a user of the sending device using the animation stream.

In another example, a computer-readable storage medium has stored thereon instructions that, when executed, cause a processing system to: establish an augmented reality (AR) media communication session with a sending device; receive data representative of one or more supported tracking schemes from the sending device; select one of the one or more supported tracking schemes to be used for the AR media communication session; send data representing the selected one of the one or more supported tracking schemes to the sending device; receive an animation stream representing tracking data conforming to the selected one of the one or more supported tracking schemes from the sending device; and animate an avatar of a user of the sending device using the animation stream.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example network including various devices for performing the techniques of this disclosure.

FIG. 2 is a block diagram illustrating an example computing system that may perform split rendering techniques.

FIG. 3 is a flowchart illustrating an example method of performing split rendering.

FIG. 4 is a block diagram illustrating an example set of devices that may perform various aspects of the techniques of this disclosure.

FIG. 5 is a conceptual diagram illustrating an example set of data that may be used in an XR session per techniques of this disclosure.

FIG. 6 is a conceptual diagram illustrating an example relationship between XR components that may be used during an XR session.

FIG. 7 is a flowchart illustrating an example method of retrieving supported tracking schemes for an XR media communication session according to techniques of this disclosure.

FIG. 8 is a flowchart illustrating an example method of sending animation stream data in a tracking format supported by a receiving device per techniques of this disclosure.

FIG. 9 is a flowchart illustrating an example method of receiving animation stream data from a sending device in a tracking format supported by a receiving device per techniques of this disclosure.

### DETAILED DESCRIPTION

In general, this disclosure describes techniques for transporting and processing extended reality (XR) media data, such as augmented reality (AR) media data, mixed reality (MR) media data, or virtual reality (VR) media data. Immersive XR experiences are based on shared virtual spaces, where people (represented by avatars) join and interact with each other and the environment. Avatars may be realistic representations of the user or may be a “cartoonish” representation. Avatars may be animated to mimic the user's body pose and facial expressions.

A display device (or another device) may capture facial movements of the user. For example, the display device may include one or more cameras or other sensors for detecting facial expressions and/or movements of the user, e.g., smiling, neutral, frowning, or mouth and jaw movements that occur when the user speaks. The display device may encode data representative of such facial movements and send the encoded data to a receiving device, such that the receiving device can animate the user's avatar consistent with the user's facial movements.

A receiving device may render received XR media data. Such rendering may be performed on a single device or using split rendering. A split rendering server may perform at least part of a rendering process to form rendered images, then stream the rendered images to a display device, such as AR glasses or a head mounted display (HMD). In general, a user may wear the display device, and the display device may capture pose information, such as a user position and orientation/rotation in real world space, which may be translated to render images for a viewport in a virtual world space.

Split rendering may enhance a user experience through providing access to advanced and sophisticated rendering that otherwise may not be possible or may place excess power and/or processing demands on AR glasses or a user equipment (UE) device. In split rendering all or parts of the 3D scene are rendered remotely on an edge application server, also referred to as a “split rendering server” in this disclosure. The results of the split rendering process are streamed down to the UE or AR glasses for display. The spectrum of split rendering operations may be wide, ranging from full pre-rendering on the edge to offloading partial, processing-extensive rendering operations to the edge.

The display device (e.g., UE/AR glasses) may stream pose predictions to the split rendering server at the edge. The display device may then receive rendered media for display from the split rendering server. The XR runtime may be configured to receive rendered data together with associated pose information (e.g., information indicating the predicted pose for which the rendered data was rendered) for proper composition and display. For instance, the XR runtime may need to perform pose correction to modify the rendered data according to an actual pose of the user at the display time.

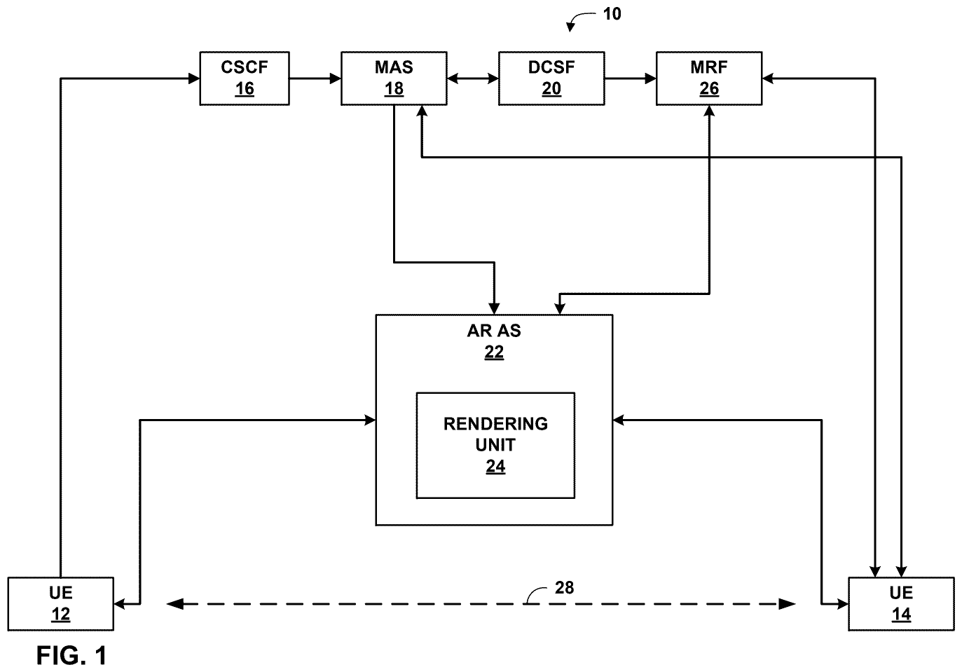

FIG. 1 is a block diagram illustrating an example network 10 including various devices for performing the techniques of this disclosure. In this example, network 10 includes user equipment (UE) devices 12, 14, call session control function (CSCF) 16, multimedia application server (MAS) 18, data channel signaling function (DCSF) 20, multimedia resource function (MRF) 26, and augmented reality application server (AR AS) 22. MAS 18 may correspond to a multimedia telephony application server, an IP Multimedia Subsystem (IMS) application server, or the like.

UEs 12, 14 represent examples of UEs that may participate in an AR communication session 28. AR communication session 28 may generally represent a communication session during which users of UEs 12, 14 exchange voice, video, and/or AR data (and/or other XR data). For example, AR communication session 28 may represent a conference call during which the users of UEs 12, 14 may be virtually present in a virtual conference room, which may include a virtual table, virtual chairs, a virtual screen or white board, or other such virtual objects. The users may be represented by avatars, which may be realistic or cartoonish depictions of the users in the virtual AR scene. The users may interact with virtual objects, which may cause the virtual objects to move or trigger other behaviors in the virtual scene. Furthermore, the users may navigate through the virtual scene, and a user's corresponding avatar may move according to the user's movements or movement inputs. In some examples, the users' avatars may include faces that are animated according to the facial movements of the users (e.g., to represent speech or emotions, e.g., smiling, thinking, frowning, or the like).

UEs 12, 14 may exchange AR media data related to a virtual scene, represented by a scene description. Users of UEs 12, 14 may view the virtual scene including virtual objects, as well as user AR data, such as avatars, shadows cast by the avatars, user virtual objects, user provided documents such as slides, images, videos, or the like, or other such data. Ultimately, users of UEs 12, 14 may experience an AR call from the perspective of their corresponding avatars (in first or third person) of virtual objects and avatars in the scene.

UEs 12, 14 may collect pose data for users of UEs 12, 14, respectively. For example, UEs 12, 14 may collect pose data including a position of the users, corresponding to positions within the virtual scene, as well as an orientation of a viewport, such as a direction in which the users are looking (i.e., an orientation of UEs 12, 14 in the real world, corresponding to virtual camera orientations). UEs 12, 14 may provide this pose data to AR AS 22 and/or to each other.

CSCF 16 may be a proxy CSCF (P-CSCF), an interrogating CSCF (I-CSCF), or serving CSCF (S-CSCF). CSCF 16 may generally authenticate users of UEs 12 and/or 14, inspect signaling for proper use, provide quality of service (QoS), provide policy enforcement, participate in session initiation protocol (SIP) communications, provide session control, direct messages to appropriate application server(s), provide routing services, or the like. CSCF 16 may represent one or more I/S/P CSCFs.

MAS 18 represents an application server for providing voice, video, and other telephony services over a network, such as a 5G network. MAS 18 may provide telephony applications and multimedia functions to UEs 12, 14.

DCSF 20 may act as an interface between MAS 18 and MRF 26, to request data channel resources from MRF 26 and to confirm that data channel resources have been allocated. DCSF 20 may receive event reports from MAS 18 and determine whether an AR communication service is permitted to be present during a communication session (e.g., an IMS communication session).

MRF 26 may be an enhanced MRF (eMRF) in some examples. In general, MRF 26 generates scene descriptions for each participant in an AR communication session. MRF 26 may support an AR conversational service, e.g., including providing transcoding for terminals with limited capabilities. MRF 26 may collect spatial and media descriptions from UEs 12, 14 and create scene descriptions for symmetrical AR call experiences. In some examples, rendering unit 24 may be included in MRF 26 instead of AR AS 22, such that MRF 26 may provide remote AR rendering services, as discussed in greater detail below.

MRF 26 may request data from UEs 12, 14 to create a symmetric experience for users of UEs 12, 14. The requested data may include, for example, a spatial description of a space around UEs 12, 14; media properties representing AR media that each of UEs 12, 14 will be sending to be incorporated into the scene; receiving media capabilities of UEs 12, 14 (e.g., decoding and rendering/hardware capabilities, such as a display resolution); and information based on detecting location, orientation, and capabilities of physical world devices that may be used in an audio-visual communication sessions. Based on this data, MRF 26 may create a scene that defines placement of each user and AR media in the scene (e.g., position, size, depth from the user, anchor type, and recommended resolution/quality); and specific rendering properties for AR media data (e.g., if 2D media should be rendered with a “billboarding” effect such that the 2D media is always facing the user). MRF 26 may send the scene data to each of UEs 12, 14 using a supported scene description format.

AR AS 22 may participate in AR communication session 28. For example, AR AS 22 may provide AR service control related to AR communication session 28. AR service control may include AR session media control and AR media capability negotiation between UEs 12, 14 and rendering unit 24.

AR AS 22 also includes rendering unit 24, in this example. Rendering unit 24 may perform split rendering on behalf of at least one of UEs 12, 14. In some examples, two different rendering units may be provided. In general, rendering unit 24 may perform a first set of rendering tasks for, e.g., UE 14, and UE 14 may complete the rendering process, which may include warping rendered viewport data to correspond to a current view of a user of UE 14. For example, UE 14 may send a predicted pose (position and orientation) of the user to rendering unit 24, and rendering unit 24 may render a viewport according to the predicted pose. However, if the actual pose is different than the predicted pose at the time video data is to be presented to a user of UE 14, UE 14 may warp the rendered data to represent the actual pose (e.g., if the user has suddenly changed movement direction or turned their head).

While only a single rendering unit is shown in the example of FIG. 1, in other examples, each of UEs 12, 14 may be associated with a corresponding rendering unit. Rendering unit 24 as shown in the example of FIG. 1 is included in AR AS 22, which may be an edge server at an edge of a communication network. However, in other examples, rendering unit 24 may be included in a local network of, e.g., UE 12 or UE 14. For example, rendering unit 24 may be included in a PC, laptop, tablet, or cellular phone of a user, and UE 14 may correspond to a wireless display device, e.g., AR/VR/MR/XR glasses or head mounted display (HMD). Although two UEs are shown in the example of FIG. 1, in general, multi-participant AR calls are also possible.

UEs 12, 14, and AR AS 22 may communicate AR data using a network communication protocol, such as Real-time Transport Protocol (RTP), which is standardized in Request for Comment (RFC) 3550 by the Internet Engineering Task Force (IETF). These and other devices involved in RTP communications may also implement protocols related to RTP, such as RTP Control Protocol (RTCP), Real-time Streaming Protocol (RTSP), Session Initiation Protocol (SIP), and/or Session Description Protocol (SDP).

In general, an RTP session may be established as follows. UE 12, for example, may receive an RTSP describe request from, e.g., UE 14. The RTSP describe request may include data indicating what types of data are supported by UE 14. UE 12 may respond to UE 14 with data indicating media streams that can be sent to UE 14, along with a corresponding network location identifier, such as a uniform resource locator (URL) or uniform resource name (URN).

UE 12 may then receive an RTSP setup request from UE 14. The RTSP setup request may generally indicate how a media stream is to be transported. The RTSP setup request may contain the network location identifier for the requested media data and a transport specifier, such as local ports for receiving RTP data and control data (e.g., RTCP data) on UE 14. UE 12 may reply to the RTSP setup request with a confirmation and data representing ports of UE 12 by which the RTP data and control data will be sent. UE 12 may then receive an RTSP play request, to cause the media stream to be “played,” i.e., sent to UE 14. UE 12 may also receive an RTSP teardown request to end the streaming session, in response to which, UE 12 may stop sending media data to UE 14 for the corresponding session.

UE 14, likewise, may initiate a media stream by initially sending an RTSP describe request to UE 12. The RTSP describe request may indicate types of data supported by UE 14. UE 14 may then receive a reply from UE 12 specifying available media streams, that can be sent to UE 14, along with a corresponding network location identifier, such as a uniform resource locator (URL) or uniform resource name (URN).

UE 14 may then generate an RTSP setup request and send the RTSP setup request to UE 12. As noted above, the RTSP setup request may contain the network location identifier for the requested media data and a transport specifier, such as local ports for receiving RTP data and control data (e.g., RTCP data) on UE 14. In response, UE 14 may receive a confirmation from UE 12, including ports of UE 12 that UE 12 will use to send media data and control data.

After establishing a media streaming session (e.g., AR communication session 28) between UE 12 and UE 14, UE 12 exchange media data (e.g., packets of media data) with UE 14 according to the media streaming session. UE 12 and UE 14 may exchange control data (e.g., RTCP data) indicating, for example, reception statistics by UE 14, such that UEs 12, 14 can perform congestion control or otherwise diagnose and address transmission faults.

Per techniques of this disclosure, UEs 12 and 14 may each support a variety of different tracking formats for tracking facial movements (e.g., for blendshapes) and/or body movements (e.g., joint poses). Tracking sensors of UEs 12, 14, such as cameras, gyroscopes, accelerometers, magnetometers, or the like, may be configured to provide tracking information in a variety of natively supported tracking formats. Likewise, UEs 12, 14 may be configured to translate natively supported tracking formats into mapped tracking formats for other devices.

In some cases, UEs 12 and 14 may support different tracking formats. For example, a native tracking format in which tracking sensors of UEs 12 track movements of a user of UE 12 may not be supported by UE 14 for animation purposes. Therefore, per techniques of this disclosure, UEs 12, 14 may engage in a negotiation process prior to engaging in an AR communication session to determine which tracking formats should be used. For example, UE 12 may send data including a list of supported tracking formats to UE 14. The data may indicate which of the supported tracking formats is a native tracking format, and which is a mapped tracking format. UE 14 may receive the list of supported tracking formats and select one of the tracking formats that UE 14 can use to animate an avatar of UE 12. In general, if a natively supported tracking format of UE 12 is also supported by UE 14, UE 14 may select the natively supported tracking format. However, if no natively supported tracking format of UE 12 is supported by UE 14, UE 14 may select a mapped tracking format that is also supported by UE 14.

In this manner, UE 12 may receive data indicating the selected tracking format from UE 14. UE 12 may then ensure that animation stream data sent to UE 14 includes tracking information in the selected tracking format. If the selected tracking format is a mapped tracking format, UE 12 may translate natively tracked tracking data from sensors representing movements of the user of UE 12 into the mapped tracking format. Otherwise, if the selected tracking format is a natively supported tracking format, UE 12 need not translate the tracking information and may send the tracking information directly to UE 14 in the native tracking format.

UE 14 may thus retrieve a base avatar model of UE 12 and animate the base avatar model using the received animation stream data including the tracking information in the selected tracking format. In this manner, UEs 12 and 14 may ensure that UE 14 is able to properly animate the base avatar model, thereby avoiding situations in which the animation stream is not usable by UE 14.

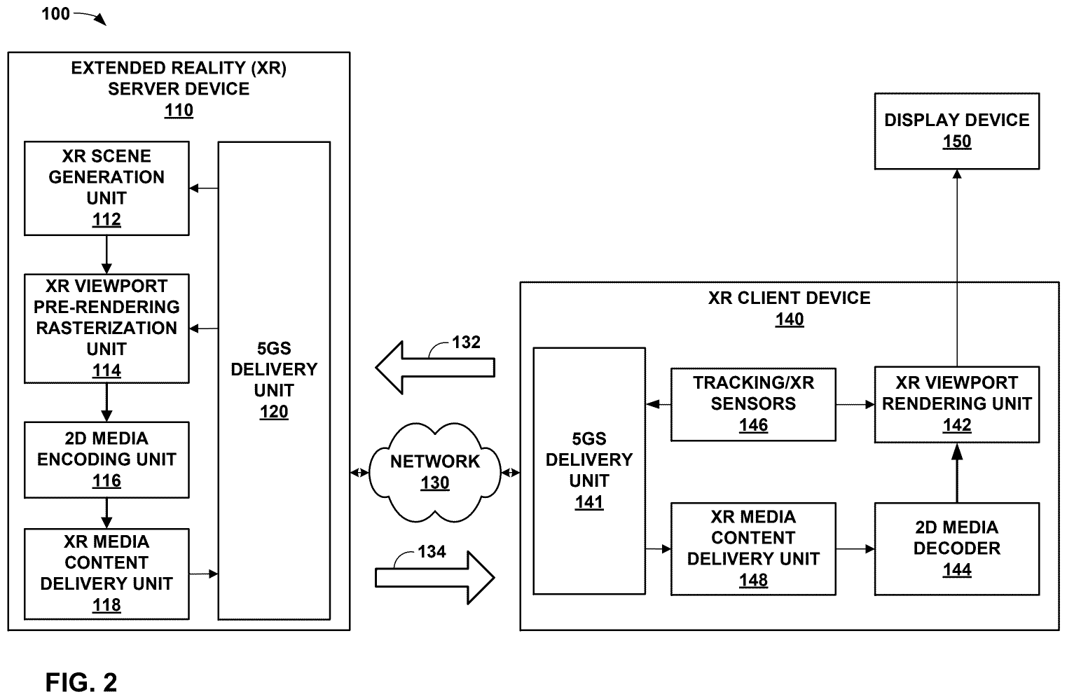

FIG. 2 is a block diagram illustrating an example computing system 100 that may perform split rendering techniques. In this example, computing system 100 includes extended reality (XR) server device 110, network 130, XR client device 140, and display device 150. XR server device 110 includes XR scene generation unit 112, XR viewport pre-rendering rasterization unit 114, 2D media encoding unit 116, XR media content delivery unit 118, and 5G System (5GS) delivery unit 120.

Network 130 may correspond to any network of computing devices that communicate according to one or more network protocols, such as the Internet. In particular, network 130 may include a 5G radio access network (RAN) including an access device to which XR client device 140 connects to access network 130 and XR server device 110. In other examples, other types of networks, such as other types of RANs, may be used. For example, network 130 may represent a wireless or wired local network. In other examples, XR client device 140 and XR server device 110 may communicate via other mechanisms, such as Bluetooth, a wired universal serial bus (USB) connection, or the like. XR client device 140 includes 5GS delivery unit 141, tracking/XR sensors 146, XR viewport rendering unit 142, 2D media decoder 144, and XR media content delivery unit 148. XR client device 140 also interfaces with display device 150 to present XR media data to a user (not shown).

In some examples, XR scene generation unit 112 may correspond to an interactive media entertainment application, such as a video game, which may be executed by one or more processors implemented in circuitry of XR server device 110. XR viewport pre-rendering rasterization unit 114 may format scene data generated by XR scene generation unit 112 as pre-rendered two-dimensional (2D) media data (e.g., video data) for a viewport of a user of XR client device 140. 2D media encoding unit 116 may encode formatted scene data from XR viewport pre-rendering rasterization unit 114, e.g., using a video encoding standard, such as ITU-T H.264/Advanced Video Coding (AVC), ITU-T H.265/High Efficiency Video Coding (HEVC), ITU-T H.266 Versatile Video Coding (VVC), or the like. XR media content delivery unit 118 represents a content delivery sender, in this example. In this example, XR media content delivery unit 148 represents a content delivery receiver, and 2D media decoder 144 may perform error handling.

In general, XR client device 140 may determine a user's viewport, e.g., a direction in which a user is looking and a physical location of the user, which may correspond to an orientation of XR client device 140 and a geographic position of XR client device 140. Tracking/XR sensors 146 may determine such location and orientation data, e.g., using cameras, accelerometers, magnetometers, gyroscopes, or the like. Tracking/XR sensors 146 provide location and orientation data (e.g., joint pose data), as well as facial movement data (e.g., blendshape data), to XR viewport rendering unit 142 and 5GS delivery unit 141. The tracking data may conform to a native tracking format. In some cases, per techniques of this disclosure, XR client device 140 may map the native tracking format tracking data to a mapped tracking format. XR client device 140 provides tracking and sensor information 132 (in a selected tracking format, which may be a native tracking format or a mapped tracking format) to XR server device 110 via network 130. XR server device 110, in turn, receives tracking and sensor information 132 and provides this information to XR scene generation unit 112 and XR viewport pre-rendering rasterization unit 114. In this manner, XR scene generation unit 112 can generate scene data for the user's viewport and location, and then pre-render 2D media data for the user's viewport using XR viewport pre-rendering rasterization unit 114. XR server device 110 may therefore deliver encoded, pre-rendered 2D media data 134 to XR client device 140 via network 130, e.g., using a 5G radio configuration. XR server device 110 may also forward tracking and sensor information 132 to a remote peer device engaged in the XR communication session with XR client device 140.

XR scene generation unit 112 may receive data representing a type of multimedia application (e.g., a type of video game), a state of the application, multiple user actions, or the like. XR viewport pre-rendering rasterization unit 114 may format a rasterized video signal. 2D media encoding unit 116 may be configured with a particular encoder/decoder (codec), bitrate for media encoding, a rate control algorithm and corresponding parameters, data for forming slices of pictures of the video data, low latency encoding parameters, error resilience parameters, intra-prediction parameters, or the like. XR media content delivery unit 118 may be configured with real-time transport protocol (RTP) parameters, rate control parameters, error resilience information, and the like. XR media content delivery unit 148 may be configured with feedback parameters, error concealment algorithms and parameters, post correction algorithms and parameters, and the like.

Raster-based split rendering refers to the case where XR server device 110 runs an XR engine (e.g., XR scene generation unit 112) to generate an XR scene based on information coming from an XR device, e.g., XR client device 140 and tracking and sensor information 132. XR server device 110 may rasterize an XR viewport and perform XR pre-rendering using XR viewport pre-rendering rasterization unit 114.

In the example of FIG. 2, the viewport is predominantly rendered in XR server device 110, but XR client device 140 is able to do latest pose correction, for example, using asynchronous time-warping or other XR pose correction to address changes in the pose. XR graphics workload may be split into rendering workload on a powerful XR server device 110 (in the cloud or the edge) and pose correction (such as asynchronous timewarp (ATW)) on XR client device 140. Low motion-to-photon latency is preserved via on-device Asynchronous Time Warping (ATW) or other pose correction methods performed by XR client device 140.

The various components of XR server device 110, XR client device 140, and display device 150 may be implemented using one or more processors implemented in circuitry, such as one or more digital signal processors (DSPs), general purpose microprocessors, application specific integrated circuits (ASICs), field programmable logic arrays (FPGAs), or other equivalent integrated or discrete logic circuitry. The functions attributed to these various components may be implemented in hardware, software, or firmware. When implemented in software or firmware, it should be understood that instructions for the software or firmware may be stored on a computer-readable medium and executed by requisite hardware.

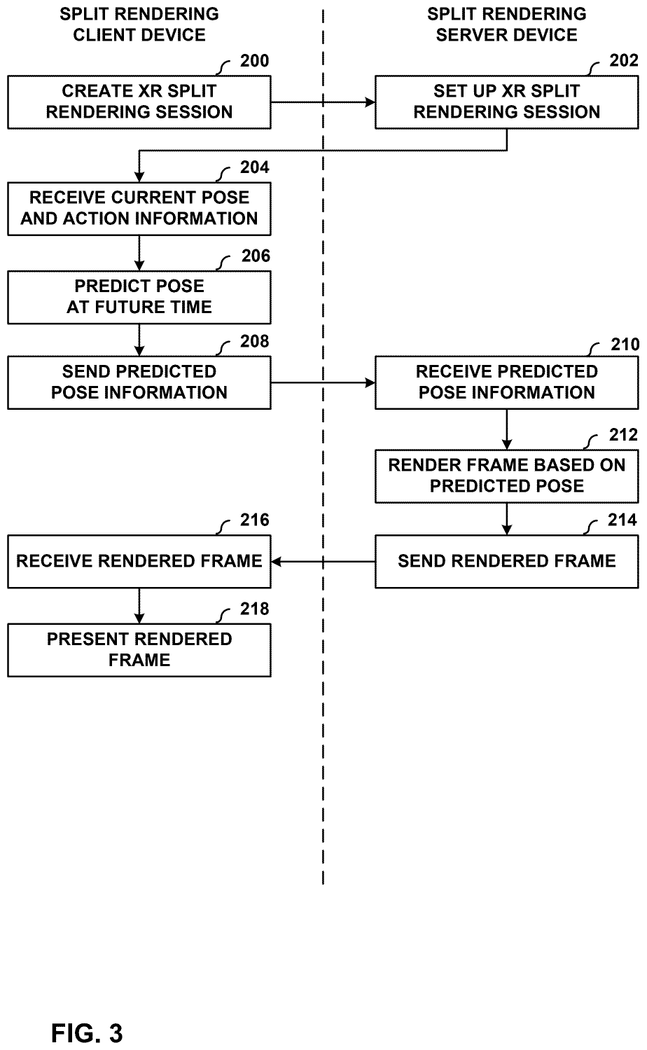

FIG. 3 is a flowchart illustrating an example method of performing split rendering according to techniques of this disclosure. The method of FIG. 3 is performed by a split rendering client device, such as XR client device 140 of FIG. 2, in conjunction with a split rendering server device, such as XR server device 110 of FIG. 2.

Initially, the split rendering client device creates an XR split rendering session (200). As discussed above, creating the XR split rendering session may include, for example, sending device information and capabilities, such as supported decoders, viewport information (e.g., resolution, size, etc.), or the like. The split rendering server device sets up an XR split rendering session (202), which may include setting up encoders corresponding to the decoders and renderers corresponding to the viewport supported by the split rendering client device.

The split rendering client device may then receive current pose and action information (204). For example, the split rendering client device may collect XR pose and movement information from tracking/XR sensors (e.g., tracking/XR sensors 146 of FIG. 2). The split rendering client device may then predict a user pose (e.g., position and orientation) at a future time (206). The split rendering client device may predict the user pose according to a current position and orientation, velocity, and/or angular velocity of the user/a head mounted display (HMD) worn by the user. The predicted pose may include a position in an XR scene, which may be represented as an {X, Y, Z} triplet value, and an orientation/rotation, which may be represented as an {RX, RY, RZ, RW} quaternion value. The split rendering client device may send the predicted pose information, (optionally) along with any actions performed by the user to the split rendering server device (208).

The split rendering server device may receive the predicted pose information (210) from the split rendering client device. The split rendering server device may then render a frame for the future time based on the predicted pose at that future time (212). For example, the split rendering server device may execute a game engine that uses the predicted pose at the future time to render an image for the corresponding viewport, e.g., based on positions of virtual objects in the XR scene relative to the position and orientation of the user's pose at the future time. The split rendering server device may then send the rendered frame to the split rendering client device (214).

The split rendering client device may then receive the rendered frame (216) and present the rendered frame at the future time (218). For example, the split rendering client device may receive a stream of rendered frames and store the received rendered frames to a frame buffer. At a current display time, the split rendering client device may determine the current display time and then retrieve one of the rendered frames from the buffer having a presentation time that is closest to the current display time.

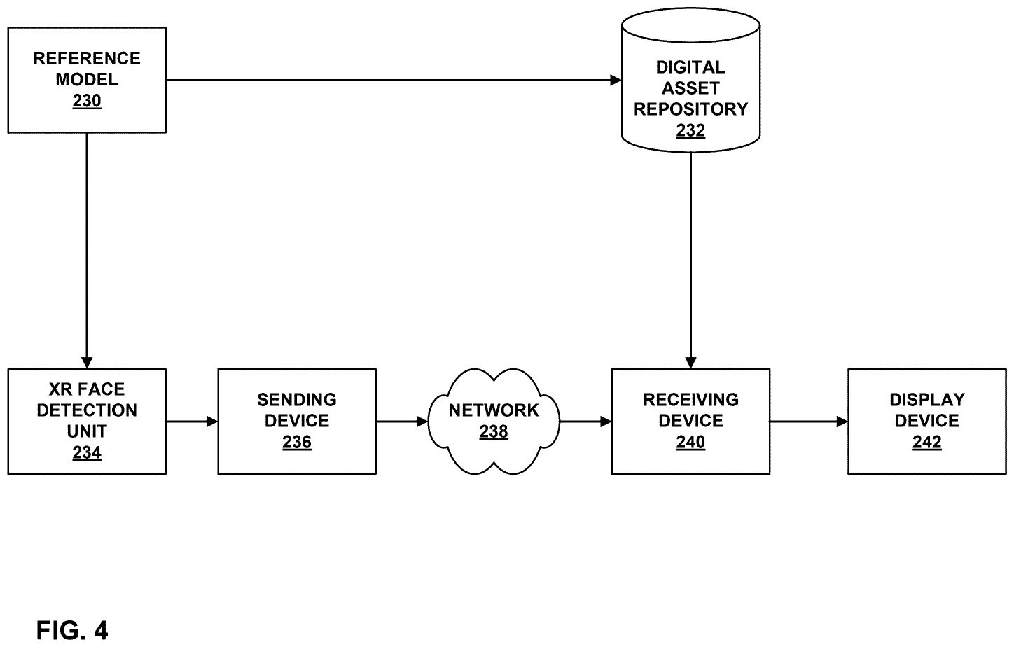

FIG. 4 is a block diagram illustrating an example set of devices that may perform various aspects of the techniques of this disclosure. The example of FIG. 4 depicts reference model 230, digital asset repository 232, XR face detection unit 234, sending device 236, network 238, receiving device 240, and display device 242. Sending device 236 may correspond to UE 12 of FIG. 1, and receiving device 240 may correspond to UE 14 of FIG. 1 and/or XR client device 140 of FIG. 2.

Sending device 236 and receiving device 240 may represent user equipment (UE) devices, such as smartphones, tablets, laptop computers, personal computers, or the like. XR face detection unit 234 may be included in an XR display device, such as an XR headset, which may be communicatively coupled to sending device 236. Likewise, display device 242 may be an XR display device, such as an XR headset.

In this example, reference model 230 includes model data for a human body and face. Digital asset repository 232 may include avatar data for a user, e.g., a user of sending device 236. Digital asset repository 232 may store the avatar data in a base avatar format. The base avatar format may differ based on software used to form the base avatar, e.g., modeling software from various vendors.

XR face detection unit 234 may detect facial expressions of a user and provide data representative of the facial expressions to sending device 236. Sending device 236 may encode the facial expression data and send the encoded facial expression data to receiving device 240 via network 238. Network 238 may represent the Internet or a private network (e.g., a VPN). Receiving device 240 may decode and reconstruct the facial expression data and use the facial expression data to animate the avatar of the user of sending device 236.

This disclosure describes techniques related to one or more application programming interfaces (APIs) between, for example, sending device 236 and XR face detection unit 234 that allow XR face detection unit 234 to send tracking information (e.g., tracked face, hand, and/or body movements) to sending device 236. Sending device 236 may execute one or more XR applications and/or one or more XR runtimes, and host one or more XR API layers. Alternatively, XR face detection unit 234 may host the one or more XR API layers. The XR API layers may be extended using vendor and/or EXT extensions to enable reception/retrieval of tracking data from, e.g., XR face detection unit 234.

Sending device 236 may convert HMD tracking information from XR face detection unit 234 to animation streams and send the animation streams to, e.g., receiving device 240 via network 238. Receiving device 240 may apply the animation streams to base avatar models stored in digital asset repository 232 corresponding to a user of sending device 236, which may result in animations being applied to the base avatar model. Such animation streams may include, for example, blendshape weights and/or joint poses.

As an example, a face tracking API may be an XR_FB_face_tracking2 API. The face tracking API may include functions such as a function to create a face tracker (e.g., xrCreateFaceTracker2FB) and a function to retrieve blendshape weights for a tracked face at a desired time (e.g., xrGetFaceExpressionWeights2FB).

As another example, a body tracking API may be an XR_FB_body_tracking API. The body tracking API may include functions such as a function to create a body tracker using a vendor extension (e.g., xrCreateBodyTrackerFB) and a function to locate body joints in a selected XR space at a desired time (e.g., xrLocateBodyJointsFB).

As another example, a hand tracking API may be an XR_EXT_hand_tracking API. The hand tracking API may include functions such as a function to create a hand tracker (e.g., xrCreateHandTrackerEXT) and a function to locate joints of the hand in a selected XR space and at a specific time (e.g., xrLocateHandJointsEXT).

In some examples, receiving device 240 may not support native tracking formats of sending device 236. Therefore, sending device 236 may send a list of tracking formats (both native and mapped) to receiving device 240, and receiving device 240 may select, from the list, one or more tracking formats that receiving device 240 also supports. Thus, sending device 236 may send the animation stream including tracking information in the selected tracking format(s) supported by receiving device 240. When the selected tracking format(s) are not native tracking formats, sending device 236 may map native tracking format data to the mapped tracking format and construct the animation stream to include the mapped tracking format data.

In this manner, sending device 236 represents an example of a device for communicating augmented reality (AR) media data, including: a memory configured to store AR media data; and a processing system implemented in circuitry and configured to: invoke a function of an application programming interface (API) to determine one or more supported tracking schemes of an augmented reality (AR) runtime; send data representative of the one or more supported tracking schemes to a receiving device with which an AR media communication session is to be performed; receive, from the receiving device, data representative of a selected one of the one or more supported tracking schemes; create a tracking session with the AR runtime using the selected one of the one or more supported tracking schemes; and send an animation stream representing tracking information conforming to the selected one of the one or more supported tracking schemes to the receiving device.

Likewise, receiving device 240 represents an example of a device for communicating augmented reality (AR) media data, including: a memory configured to store AR media data; and a processing system implemented in circuitry and configured to: establish an augmented reality (AR) media communication session with a sending device; receive data representative of one or more supported tracking schemes from the sending device; select one of the one or more supported tracking schemes to be used for the AR media communication session; send data representing the selected one of the one or more supported tracking schemes to the sending device; receive an animation stream representing tracking data conforming to the selected one of the one or more supported tracking schemes from the sending device; and animate an avatar of a user of the sending device using the animation stream.

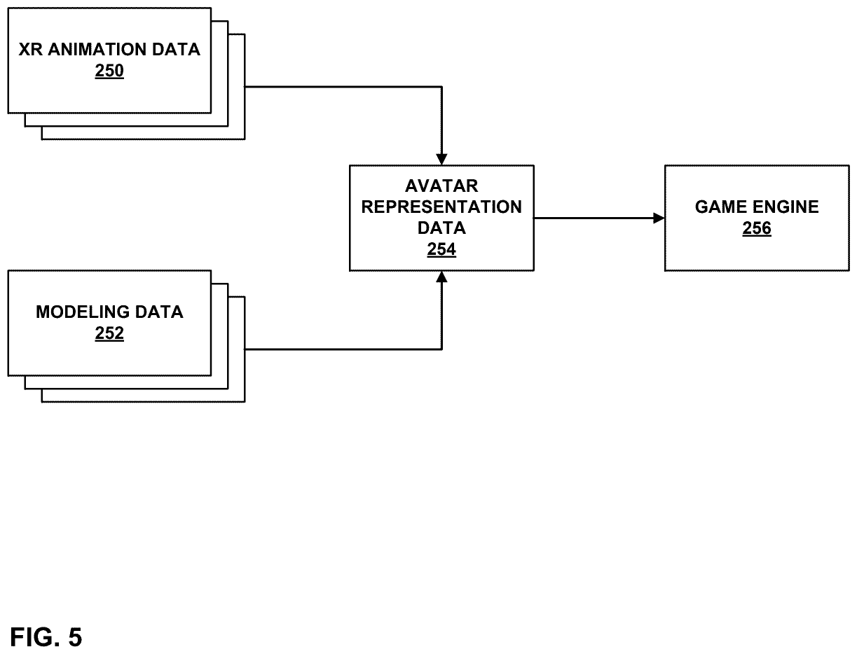

FIG. 5 is a conceptual diagram illustrating an example set of data that may be used in an XR session per techniques of this disclosure. In this example, FIG. 5 depicts XR animation data 250, modeling data 252, avatar representation data 254, and game engine 256. Modeling data 252 may represent one or more sets of data used to form a base avatar model, which may originate from various sources, such as modeling software (e.g., Blender or Maya), glTF, universal scene description (USD), VRM Consortium, MetaHuman, or the like. XR animation data 250 may represent one or more tracked movements of a user to be used to animate the base model, which may originate from OpenXR, ARKit, MediaPipe, or the like. The combination of the base model and the animation data may be formed into avatar representation data 254, which game engine 256 may use to display an animated avatar. Game engine 256 may represent Unreal Engine, Unity Engine, Godot Engine, 3GPP, or the like.

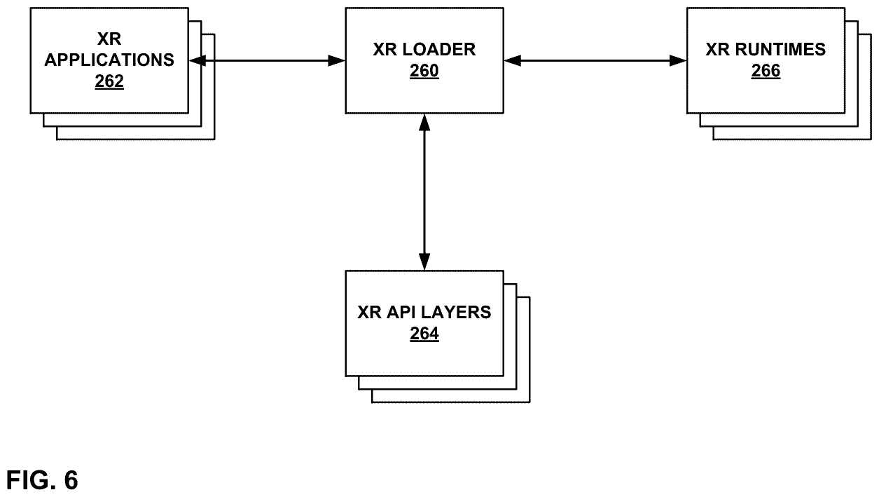

FIG. 6 is a conceptual diagram illustrating an example relationship between XR components that may be used during an XR session. The example of FIG. 6 depicts XR applications 262, XR loader 260, XR runtimes 266, and XR API layers 264. In one example, XR loader 260 may be an OpenXR Loader, XR applications 262 may be OpenXR applications, XR runtimes may be OpenXR runtimes, and XR API layers 264 may be OpenXR API layers.

This relationship between components may use XR API layers 264 to interface with XR runtimes 266, which may address fragmentation. This relationship between components may also enable composition of multiple composition layers to create a display frame. This relationship between components may consolidate user tracking based on multiple coordinate systems and make this information accessible through pose queries in the API. This relationship between components is extensible through API extensions, which may be vender or Khronos extensions, for example.

Different vendors of HMD devices or tracking devices may allow for different tracking capabilities. For example, face tracking may differ by definitions and number of tracked facial expressions and/or blendshapes. As another example, body tracking may differ in skeleton animation, joint hierarchies, numbers of joints, parts of the skeleton that are tracked, dimensions of bones, or the like.

Even extensions from the same vendor may evolve over time and introduce changes. API extensions in conventional systems may be similar in functionality to each other, but due to changes, may opt for different vendor extensions. For example, XR_FB_face_tracking, XR_FB_face_tracking2, XR_HTC_facial_tracking for face tracking. This may result in a multitude of vendor extensions, even from a single vendor, which may increase fragmentation and confuse developers.

This disclosure describes a set of API extensions to unify face, body, and hand tracking, while also allowing different vendors and devices to implement their peculiarities without the need for developing completely new extensions. Thus, these techniques allow for vendors to register their facial expression schemes and their skeleton/armature/joint structure. These techniques also allow for a single extension for body tracking and one extension for face tracking. Per these techniques, a developer may query an XR runtime through an API to detect which facial expression scheme(s) and which body skeleton(s) the XR runtime supports natively. Additionally, XR runtime may query which facial expression schemes and body expressions are supported through a mapping process. The developer may then select one of the schemes and initialize tracking based on the selection.

For example, an XR runtime may provide an API including a function for discovering supported facial expression schemes. As an example, such an API may include a function (e.g., xrEnumerateFacialExpressionSchemes) that returns a list of supported facial expression schemes that can be tracked by the XR runtime. A registry of facial expression schemes may then be created and maintained by a central organization, such as the OpenXR group. Each vendor can then register their own facial expression schemes. A query submitted to the API may result in an array of elements, each representing a supported facial expression scheme. For example, the following code snippet represents an example set of data that may be returned for a facial expression scheme (e.g., xrFacialExpressionScheme):

```
typedef struct xrFacialExpressionScheme {
  XrStructureType type;
  const void* next;
  XrFacialSchemeType facialExpressionSchemeId;
  char schemeName[XR_MAX_SCHEME_NAME_SIZE];
  const XrBool32 isNative;
} XrFacialExpressionScheme;
```

The XrFacialSchemeType can be defined as an enumeration that lists all registered facial expression schemes. A value of False for isNative may indicate that the scheme is supported through applying a mapping and is not natively supported. This may help with interoperability, but the tracking accuracy may suffer.

The API may provide a similar (additional or alternative) function to discover supported skeleton schemes. For example, an API function (e.g., xrEnumerateSkeletonSchemes) may list all supported body and/or hand skeletons that can be tracked by the XR runtime. In some cases, only a subset of the joints of a skeleton is supported by the tracking scheme. For example, due to the limitation in the view field of the cameras in the HMD, only the upper part of the body may be tracked by the XR runtime running on that HMD. A list of the indices of the supported joints may also be returned as part of this query. For example, the following code snippet represents an example set of data that may be returned for a skeleton scheme:

```
typedef struct xrSkeletonScheme {
  XrStructureType type;
  const void* next;
  XrSkeletonSchemeType skeletonSchemeId;
  char schemeName[XR_MAX_SCHEME_NAME_SIZE];
  const XrBool32 isNative;
  const uint32_t supportedJoints[XR_MAX_JOINT_COUNT];
} XrSkeletonScheme;
```

Similar to the example facial expression query above, isNative having a value of false for the skeleton scheme may indicate that the joint poses using this skeleton schema are mapped from another native schema and are not natively generated by the XR runtime.

Calls to track the face, body, and/or hands of a user may be modified to include a desired scheme, e.g., as follows:

```
XrResult xrCreateFaceTracker (XrSession session, const
XrFaceTrackerCreateInfo* createInfo, XrFaceTracker* faceTracker);
typedef struct XrFaceTrackerCreateInfo {
  XrStructureType type;
  const void* next;
  uint32_t requestedDataSourceCount;
  XrFacialSchemeType facialSchemeType;
} XrFaceTrackerCreateInfo;
XrResult xrCreateBodyTracker( XrSession session, const
XrBodyTrackerCreateInfo* createInfo, XrBodyTracker* bodyTracker);
typedef struct XrBodyTrackerCreateInfo {
  XrStructureType type;
  const void* next;
  XrSkeletonSchemeType skeletonSchemeType;
  const uint32_t trackedJoints[XR_MAX_JOINT_COUNT];
} XrBodyTrackerCreateInfo;
```

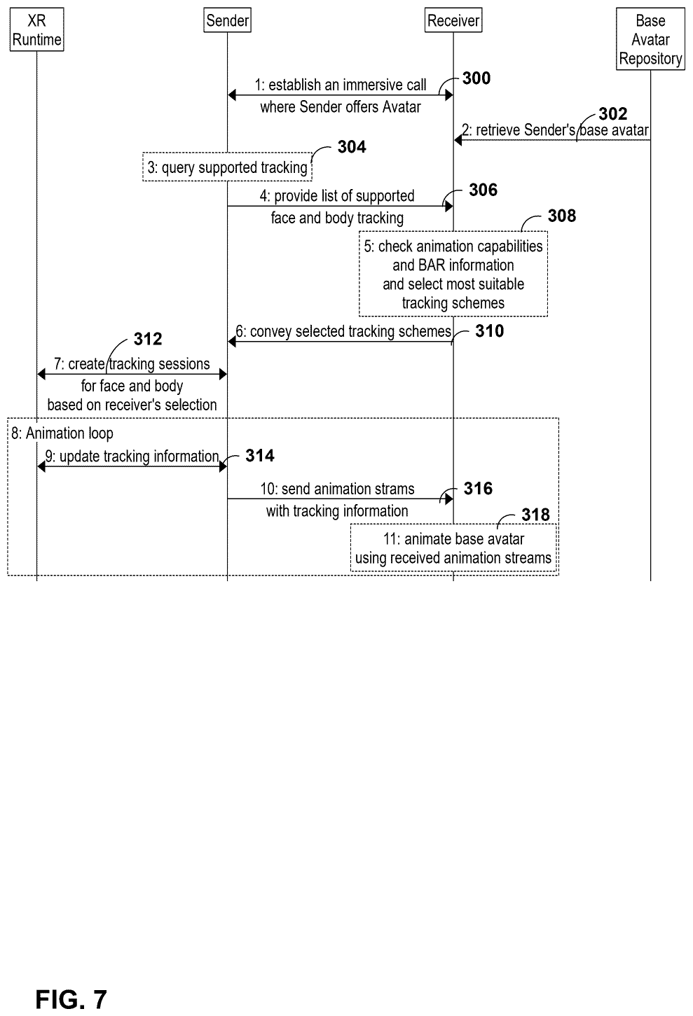

FIG. 7 is a flowchart illustrating an example method of retrieving supported tracking schemes for an XR media communication session according to techniques of this disclosure. The supported tracking schemes may include any or all of face, hand, and/or body skeleton tracking schemes.

Initially, in this example, a sending device (e.g., UE 12 of FIG. 1 or sending device 236 of FIG. 4) and a receiving device (e.g., UE 14 of FIG. 1 or receiving device 240 of FIG. 4) involved in an XR media communication session establish an immersive call (300). The sending device may offer an avatar representative of a user of the sending device. Data for the avatar may be stored in a digital asset repository, such as digital asset repository 232 of FIG. 4, or the sending device may send data for the avatar directly to the receiving device. In the case where the data for the avatar is stored in the digital asset repository, the receiving device retrieves the base avatar data from the base avatar repository (302).

The sending device may then query supported tracking schemes (304) as discussed above. For example, the sending device may invoke one or more functions via one or more APIs (e.g., provided by the tracking device(s)) and the functions may return data for one or more supported tracking schemes. Such tracking schemes may be for any or all of facial expressions, body movements, hand movements, or the like. The sending device may then provide a list of supported face and/or body tracking schemes to the receiving device (306).

The receiving device may then determine animation capabilities and BAR information and select a most suitable tracking scheme (308). In some cases, the receiving device may select any or all of a suitable face tracking scheme, a suitable body tracking scheme, and a suitable hand tracking scheme. The receiving device may then convey the selected tracking scheme(s) to the sending device (310).

The sending device may then create tracking sessions for the user's face and/or body based on the selected tracking schemes received from the receiving device using the XR runtime (312). The sending device may then receive tracking information from the XR runtime and update session tracking information accordingly (314). For example, the tracking information may represent positions and locations of bones and joints, as well as facial expressions of a user of the sending device. The sending device may then convert this tracked data into animation streams and send the animation streams with tracking information to the receiving device (316). Ultimately, the receiving device may then animate the base avatar of the user of the sending device using the received animation streams (318).

In this manner, the techniques of this disclosure may be used to unify access to tracking functionality via an API, e.g., in OpenXR API. The techniques also include querying supported facial expression schemes and body/hand skeleton schemes to determine supported schemes. This disclosure describes a common set of API calls that may work with any scheme. These techniques thereby offer tracking based on different schemes.

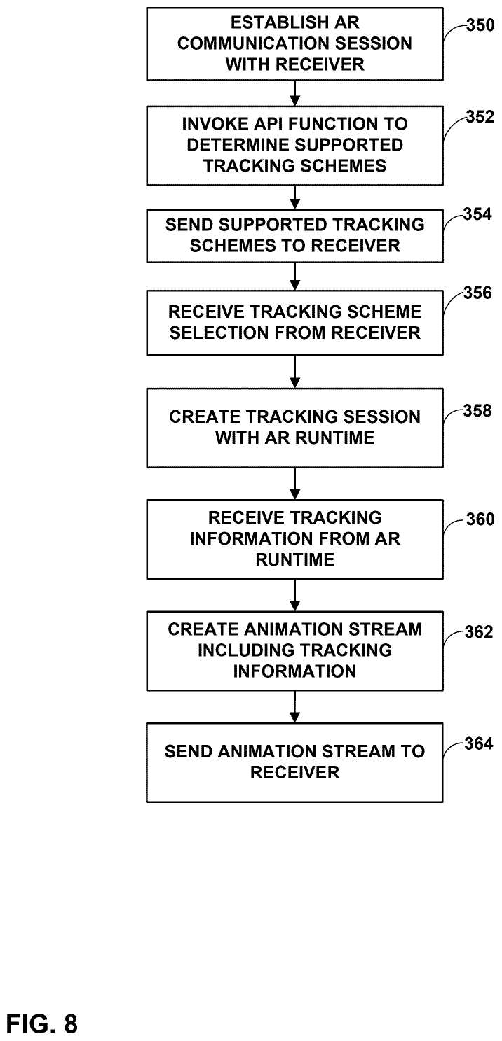

FIG. 8 is a flowchart illustrating an example method of sending animation stream data in a tracking format supported by a receiving device per techniques of this disclosure. The method of FIG. 8 may be performed by a sending device of an augmented reality (AR) communication session including a receiving device. For example, the sending device may correspond to UE 12 of FIG. 1, sending device 236 of FIG. 4, or the like, while the receiving device may correspond to UE 14 of FIG. 1, XR client device 140 of FIG. 2, or receiving device 240 of FIG. 4. For purposes of example, the method of FIG. 8 is described with respect to sending device 236 and receiving device 240 of FIG. 4.

Initially, sending device 236 establishes an AR communication session with receiving device 240 (350). This session establishment process may include, for example, sending data representing a base avatar model of a user of sending device 236 to receiving device 240. The base avatar model may include one or more meshes (e.g., a body, a set of facial features, and accessories, such as clothing, jewelry, or the like) and an animatable rig (skeleton) having weights associated with the meshes. The skeleton may also include a set of bones and joints, which may allow the meshes to be moved according to the corresponding weights when the bones are moved (e.g., when the joints are posed).

Sending device 236 may invoke a function of an application programming interface (API) to determine tracking schemes supported by an AR runtime being used to track movements of a user of the AR runtime (352). The supported tracking schemes may include both one or more native tracking schemes and one or more mapped tracking schemes. The supported tracking schemes may include facial tracking schemes, hand tracking schemes, and/or body tracking schemes, any or all of which may be native and/or mapped. The function of the API may return an enumerated facial expression schemes data structure (e.g., the example xrFacialExpressionScheme discussed above) and/or an enumerated skeleton schemes data structure (e.g., the example xrSkeletonScheme discussed above). Sending device 236 may send data representing the supported tracking schemes to receiving device 240 (354). In response, sending device 236 may receive a selection of one of the supported tracking schemes from receiving device 240 (356).

Sending device 236 may then create a tracking session with the AR runtime (358). Creation of the tracking session may include sending the selected tracking scheme to the AR runtime, to cause the AR runtime to provide tracking information in the selected tracking scheme. Accordingly, during the AR communication session, sending device 236 may receive tracking information from the AR runtime (360) representing movements (body and/or facial movements) of the user of AR runtime. The received tracking information may be in the selected tracking format. Thus, sending device 236 may create an animation stream including the tracking information (362) and send the animation stream to receiving device 240 (364).

In this manner, the method of FIG. 8 represents an example of a method of communicating augmented reality (AR) media data, including: invoking a function of an application programming interface (API) to determine one or more supported tracking schemes of an augmented reality (AR) runtime; sending data representative of the one or more supported tracking schemes to a receiving device with which an AR media communication session is to be performed; receiving, from the receiving device, data representative of a selected one of the one or more supported tracking schemes; creating a tracking session with the AR runtime using the selected one of the one or more supported tracking schemes; and sending an animation stream representing tracking information conforming to the selected one of the one or more supported tracking schemes to the receiving device.

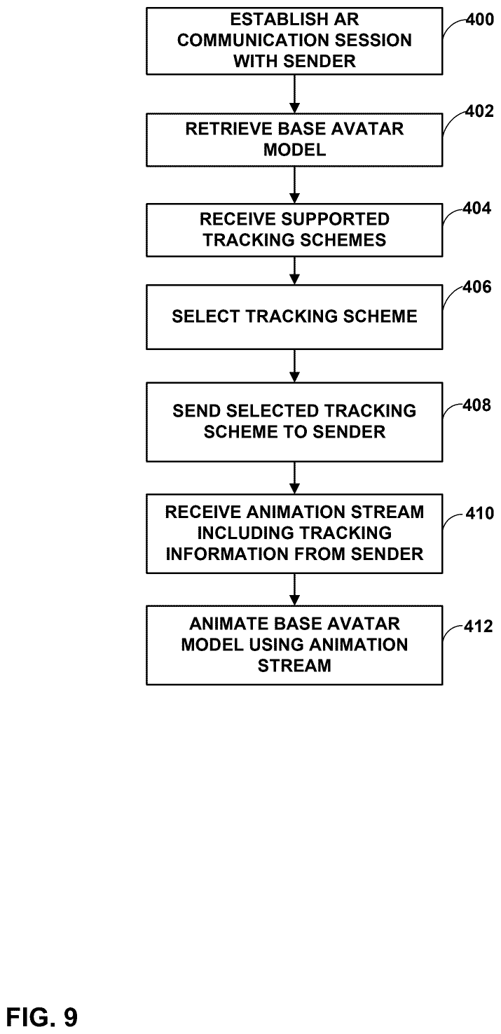

FIG. 9 is a flowchart illustrating an example method of receiving animation stream data from a sending device in a tracking format supported by a receiving device per techniques of this disclosure. The method of FIG. 9 may be performed by a receiving device of an augmented reality (AR) communication session including a sending device. For example, the sending device may correspond to UE 12 of FIG. 1, sending device 236 of FIG. 4, or the like, while the receiving device may correspond to UE 14 of FIG. 1, XR client device 140 of FIG. 2, or receiving device 240 of FIG. 4. For purposes of example, the method of FIG. 8 is described with respect to sending device 236 and receiving device 240 of FIG. 4.

Initially, receiving device 240 may establish an AR communication session with sending device 236 (400). Such session establishment may include receiving device 240 receiving data representing an avatar of a user of sending device 236. The data may include, for example, a network location of a base avatar repository (BAR) storing the avatar data, as well as authentication and authorization data that allows receiving device 240 to retrieve the avatar data from the BAR. Thus, receiving device 240 may retrieve the base avatar model from the BAR (402). The avatar data may include data defining a skeleton of the base avatar model, e.g., including a hierarchical arrangement of bones and joints of the base avatar model. The skeleton may conform to certain tracking models for purposes of animating the skeleton and a corresponding mesh of the base avatar model.

Receiving device 240 may also receive data representing supported tracking schemes from sending device 236 (404). The supported tracking schemes may include a list of various tracking schemes (e.g., facial tracking schemes, hand tracking schemes, and/or body tracking schemes), as well as data indicating for each tracking scheme in the list whether the tracking scheme is natively supported by sending device 236. Receiving device 240 may select one or more of the tracking schemes that is supported by receiving device 240 for purposes of animation, as well as those tracking schemes that are supported by the base avatar model. In particular, receiving device 240 may prioritize selection of natively supported tracking schemes, if possible, but if not, select mapped tracking schemes for facial animation, hand animation, and/or body animation. Receiving device 240 may then send the selected tracking scheme(s) to sending device 236 (408).

Thus, during the AR communication session, receiving device 240 may receive an animation stream including tracking information from sending device 236 (410). In particular, the tracking information may be formatted according to the selected tracking scheme(s). Receiving device 240 may therefore animate the base avatar model using the animation stream (412).

In this manner, the method of FIG. 9 represents an example of a method of communicating augmented reality (AR) media data, including: establishing an augmented reality (AR) media communication session with a sending device; receiving data representative of one or more supported tracking schemes from the sending device; selecting one of the one or more supported tracking schemes to be used for the AR media communication session; sending data representing the selected one of the one or more supported tracking schemes to the sending device; receiving an animation stream representing tracking data conforming to the selected one of the one or more supported tracking schemes from the sending device; and animating an avatar of a user of the sending device using the animation stream.

In some examples, the receiving device described with respect to FIG. 9 may be implemented as a split rendering system, e.g., as discussed with respect to FIG. 2 above. In such case, the supported tracking format may be supported by an upstream split rendering server and/or the local XR client device. Likewise, the local XR client device may have its own set of supported tracking frameworks, both native and mapped, which may be sent to the sending device (i.e., the other participant in the AR communication session).

In some examples, there may be more than two participants in the AR communication session. In such cases, each participant device may send tracking data to each other participant in a format selected by that respective participant. Alternatively, the AR communication session may include one or more mapping servers configured to map received tracking data into a format selected by a participant, then send that participant animation stream data including tracking information in the selected format. Thus, for example, if the AR communication session includes three participants: A, B, and C, participant A may select a format for tracking data, participants B and C may send tracking data to the mapping server, and the mapping server may translate the tracking data from participants B and C into the format selected by participant A. In such an example, the mapping server and each participant in the AR communication session may engage in a tracking format negotiation similar to that described herein, where the mapping server receives supported tracking formats from each participant (including data representing whether the formats are native or mapped). The mapping server may select formats supported by respective participants (natively when possible), and determine formats that can be used by each respective participant for animating and rendering an avatar. The mapping server may translate received tracking data to a different format when necessary, or simply forward received tracking data to respective participants when possible (e.g., if participant B supports a format also supported by participant A, the mapping server may forward tracking information from participant A to participant B without translation).

Various examples of the techniques of this disclosure are summarized in the following clauses:

Clause 1. A method of communicating extended reality (XR) media data, the method comprising: invoking a function of an application programming interface (API) to determine one or more supported tracking schemes of an extended reality (XR) runtime; sending data representative of the one or more supported tracking schemes to a receiving device with which an XR media communication session is to be performed; receiving, from the receiving device, data representative of a selected one of the one or more supported tracking schemes; creating a tracking session with the XR runtime using the selected one of the one or more supported tracking schemes; and sending an animation stream representing tracking information conforming to the selected one of the one or more supported tracking schemes to the receiving device.

Clause 2. The method of clause 1, wherein the one or more supported tracking schemes include one or more facial tracking schemes.

Clause 3. The method of clause 2, wherein invoking the function of the API to determine the one or more supported tracking schemes further comprises receiving data of an enumerated facial expression schemes data structure representing one or more supported facial tracking schemes.

Clause 4. The method of clause 3, wherein the enumerated facial expression schemes data structure comprises: typedef struct xrFacialExpressionScheme {XrStructureType type; const void* next; XrFacialSchemeType facialExpressionSchemeId; char schemeName[XR_MAX_SCHEME_NAME_SIZE]; const XrBool32 isNative;} XrFacialExpressionScheme.

Clause 5. The method of any of clauses 2-4, wherein creating the tracking session comprises creating a facial tracking session using a facial tracking function of the API.

Clause 6. The method of clause 5, wherein the facial tracking function comprises XrResult xrCreateFaceTracker (XrSession session, const XrFaceTrackerCreateInfo* createInfo, XrFaceTracker* faceTracker).

Clause 7. The method of any of clauses 1-6, wherein the one or more supported tracking schemes include one or more body tracking schemes.

Clause 8. The method of any of clauses 1-7, wherein the one or more supported tracking schemes include one or more hand tracking schemes.

Clause 9. The method of any of clauses 7 and 8, wherein invoking the function of the API to determine the one or more supported tracking schemes further comprises receiving data of an enumerated skeleton scheme data structure representing one or more supported body or hand tracking schemes.

Clause 10. The method of clause 9, wherein the enumerated skeleton schemes data structure comprises: typedef struct xrSkeletonScheme {XrStructureType type; const void* next; XrSkeletonSchemeType skeletonSchemeId; char schemeName[XR_MAX_SCHEME_NAME_SIZE]; const XrBool32 isNative; const uint32_t supportedJoints[XR_MAX_JOINT_COUNT];} XrSkeletonScheme.

Clause 11. The method of any of clauses 9 and 10, wherein creating the tracking session comprises creating a body tracking session using a skeleton tracking function of the API.

Clause 12. The method of clause 11, wherein the skeleton tracking function of the API comprises XrResult xrCreateBodyTracker (XrSession session, const XrBodyTrackerCreateInfo* createInfo, XrBody Tracker* bodyTracker).

Clause 13. A method of communicating extended reality (XR) media data, the method comprising: establishing an extended reality (XR) media communication session with a sending device; receiving data representative of one or more supported tracking schemes from the sending device; selecting one of the one or more supported tracking schemes to be used for the XR media communication session; sending data representing the selected one of the one or more supported tracking schemes to the sending device; receiving an animation stream representing tracking data conforming to the selected one of the one or more supported tracking schemes from the sending device; and animating an avatar of a user of the sending device using the animation stream.

Clause 14. The method of clause 13, wherein the one or more supported tracking schemes include one or more facial tracking schemes.

Clause 15. The method of any of clauses 13 and 14, wherein the one or more supported tracking schemes include one or more body tracking schemes.

Clause 16. The method of any of clauses 13-15, wherein the one or more supported tracking schemes include one or more hand tracking schemes.

Clause 17. The method of any of clauses 13-16, wherein selecting the one of the one or more supported tracking schemes comprises selecting the one of the one or more supported tracking schemes based on animation capabilities.

Clause 18. The method of any of clauses 13-17, further comprising retrieving data for the avatar from an avatar repository.

Clause 19. A method comprising a combination of the method of any of clauses 1-12 and the method of any of clauses 13-18.

Clause 20. A device for communication extended reality (XR) media data, the device comprising one or more means for performing the method of any of clauses 1-19.

Clause 21. The device of clause 19, wherein the one or more means comprise a processing system implemented in circuitry, and a memory configured to store XR media data.

Clause 22. A sending device for communicating extended reality (XR) media data, the sending device comprising: means for invoking a function of an application programming interface (API) to determine one or more supported tracking schemes of an extended reality (XR) runtime; means for sending data representative of the one or more supported tracking schemes to a receiving device with which an XR media communication session is to be performed; means for receiving, from the receiving device, data representative of a selected one of the one or more supported tracking schemes; means for creating a tracking session with the XR runtime using the selected one of the one or more supported tracking schemes; and means for sending an animation stream representing tracking information conforming to the selected one of the one or more supported tracking schemes to the receiving device.

Clause 23. A receiving device for communicating extended reality (XR) media data, the receiving device comprising: means for establishing an extended reality (XR) media communication session with a sending device; means for receiving data representative of one or more supported tracking schemes from the sending device; means for selecting one of the one or more supported tracking schemes to be used for the XR media communication session; means for sending data representing the selected one of the one or more supported tracking schemes to the sending device; means for receiving an animation stream representing tracking data conforming to the selected one of the one or more supported tracking schemes from the sending device; and means for animating an avatar of a user of the sending device using the animation stream.

Clause 24. A method of communicating extended reality (XR) media data, the method comprising: invoking a function of an application programming interface (API) to determine one or more supported tracking schemes of an extended reality (XR) runtime; sending data representative of the one or more supported tracking schemes to a receiving device with which an XR media communication session is to be performed; receiving, from the receiving device, data representative of a selected one of the one or more supported tracking schemes; creating a tracking session with the XR runtime using the selected one of the one or more supported tracking schemes; and sending an animation stream representing tracking information conforming to the selected one of the one or more supported tracking schemes to the receiving device.

Clause 25. The method of clause 24, wherein the one or more supported tracking schemes include one or more facial tracking schemes.

Clause 26. The method of clause 25, wherein invoking the function of the API to determine the one or more supported tracking schemes further comprises receiving data of an enumerated facial expression schemes data structure representing one or more supported facial tracking schemes.

Clause 27. The method of clause 26, wherein the enumerated facial expression schemes data structure comprises: typedef struct xrFacialExpressionScheme {XrStructureType type; const void* next; XrFacialSchemeType facialExpressionSchemeId; char schemeName[XR_MAX_SCHEME_NAME_SIZE]; const XrBool32 isNative;} XrFacialExpressionScheme.

Clause 28. The method of clause 24, wherein creating the tracking session comprises creating a facial tracking session using a facial tracking function of the API.

Clause 29. The method of clause 28, wherein the facial tracking function comprises XrResult xrCreateFaceTracker (XrSession session, const XrFaceTrackerCreateInfo* createInfo, XrFaceTracker* faceTracker).

Clause 30. The method of clause 24, wherein the one or more supported tracking schemes include one or more body tracking schemes.

Clause 31. The method of clause 30, wherein invoking the function of the API to determine the one or more supported tracking schemes further comprises receiving data of an enumerated skeleton scheme data structure representing one or more supported body tracking schemes.

Clause 32. The method of clause 30, wherein the enumerated skeleton schemes data structure comprises: typedef struct xrSkeletonScheme {XrStructureType type; const void* next; XrSkeletonSchemeType skeletonSchemeId; char schemeName[XR_MAX_SCHEME_NAME_SIZE]; const XrBool32 isNative; const uint32_t supportedJoints[XR_MAX_JOINT_COUNT];} XrSkeletonScheme.

Clause 33. The method of clause 30, wherein creating the tracking session comprises creating a body tracking session using a skeleton tracking function of the API.

Clause 34. The method of clause 33, wherein the skeleton tracking function of the API comprises XrResult xrCreateBodyTracker (XrSession session, const XrBodyTrackerCreateInfo* createInfo, XrBody Tracker* bodyTracker).

Clause 35. The method of clause 24, wherein the one or more supported tracking schemes include one or more hand tracking schemes.

Clause 36. The method of clause 35, wherein invoking the function of the API to determine the one or more supported tracking schemes further comprises receiving data of an enumerated skeleton scheme data structure representing one or more supported hand tracking schemes.

Clause 37. The method of clause 35, wherein the enumerated skeleton schemes data structure comprises: typedef struct xrSkeletonScheme {XrStructureType type; const void* next; XrSkeletonSchemeType skeletonSchemeId; char schemeName[XR_MAX_SCHEME_NAME_SIZE]; const XrBool32 isNative; const uint32_t supportedJoints[XR_MAX_JOINT_COUNT];} XrSkeletonScheme.

Clause 38. A method of communicating extended reality (XR) media data, the method comprising: establishing an extended reality (XR) media communication session with a sending device; receiving data representative of one or more supported tracking schemes from the sending device; selecting one of the one or more supported tracking schemes to be used for the XR media communication session; sending data representing the selected one of the one or more supported tracking schemes to the sending device; receiving an animation stream representing tracking data conforming to the selected one of the one or more supported tracking schemes from the sending device; and animating an avatar of a user of the sending device using the animation stream.

Clause 39. The method of clause 38, wherein the one or more supported tracking schemes include one or more facial tracking schemes.

Clause 40. The method of clause 38, wherein the one or more supported tracking schemes include one or more body tracking schemes.

Clause 41. The method of clause 38, wherein the one or more supported tracking schemes include one or more hand tracking schemes.

Clause 42. The method of clause 38, wherein selecting the one of the one or more supported tracking schemes comprises selecting the one of the one or more supported tracking schemes based on animation capabilities.

Clause 43. The method of clause 38, further comprising retrieving data for the avatar from an avatar repository.

Clause 44. A method of communicating augmented reality (AR) media data, the method comprising: invoking a function of an application programming interface (API) to determine one or more supported tracking schemes of an augmented reality (AR) runtime; sending data representative of the one or more supported tracking schemes to a receiving device with which an AR media communication session is to be performed; receiving, from the receiving device, data representative of a selected one of the one or more supported tracking schemes; creating a tracking session with the AR runtime using the selected one of the one or more supported tracking schemes; and sending an animation stream representing tracking information conforming to the selected one of the one or more supported tracking schemes to the receiving device.

Clause 45. The method of clause 44, wherein the one or more supported tracking schemes include one or more facial tracking schemes.

Clause 46. The method of clause 45, wherein invoking the function of the API to determine the one or more supported tracking schemes further comprises receiving data of an enumerated facial expression schemes data structure representing one or more supported facial tracking schemes.

Clause 47. The method of clause 46, wherein the enumerated facial expression schemes data structure comprises: typedef struct xrFacialExpressionScheme {XrStructureType type; const void* next; XrFacialSchemeType facialExpressionSchemeId; char schemeName[XR_MAX_SCHEME_NAME_SIZE]; const XrBool32 isNative;} XrFacialExpressionScheme.

Clause 48. The method of clause 45, wherein creating the tracking session comprises creating a facial tracking session using a facial tracking function of the API.

Clause 49. The method of clause 48, wherein the facial tracking function comprises XrResult xrCreateFaceTracker (XrSession session, const XrFaceTrackerCreateInfo* createInfo, XrFaceTracker* faceTracker).

Clause 50. The method of clause 44, wherein the one or more supported tracking schemes include one or more hand tracking schemes.

Clause 51. The method of clause 44, wherein the one or more supported tracking schemes include one or more body tracking schemes.

Clause 52. The method of clause 51, wherein invoking the function of the API to determine the one or more supported tracking schemes further comprises receiving data of an enumerated skeleton scheme data structure representing one or more supported body or hand tracking schemes.

Clause 53. The method of clause 52, wherein the enumerated skeleton schemes data structure comprises: typedef struct xrSkeletonScheme {XrStructureType type; const void* next; XrSkeletonSchemeType skeletonSchemeId; char schemeName[XR_MAX_SCHEME_NAME_SIZE]; const XrBool32 isNative; const uint32_t supportedJoints[XR_MAX_JOINT_COUNT];} XrSkeletonScheme.

Clause 54. The method of clause 52, wherein creating the tracking session comprises creating a body tracking session using a skeleton tracking function of the API.

Clause 55. The method of clause 54, wherein the skeleton tracking function of the API comprises XrResult xrCreateBodyTracker (XrSession session, const XrBodyTrackerCreateInfo* createInfo, XrBodyTracker* body Tracker).

Clause 56. A device for communicating augmented reality (AR) media data, the device comprising: a memory configured to store AR media data; and a processing system implemented in circuitry and configured to: invoke a function of an application programming interface (API) to determine one or more supported tracking schemes of an augmented reality (AR) runtime; send data representative of the one or more supported tracking schemes to a receiving device with which an AR media communication session is to be performed; receive, from the receiving device, data representative of a selected one of the one or more supported tracking schemes; create a tracking session with the AR runtime using the selected one of the one or more supported tracking schemes; and send an animation stream representing tracking information conforming to the selected one of the one or more supported tracking schemes to the receiving device.

Clause 57. The device of clause 56, wherein the one or more supported tracking schemes include one or more facial tracking schemes, one or more hand tracking schemes, or one or more body tracking schemes.

Clause 58. The device of clause 57, wherein to invoke the function of the API to determine the one or more supported tracking schemes, the processing system is further configured to receive data of at least one of an enumerated facial expression schemes data structure representing one or more supported facial tracking schemes or an enumerated skeleton scheme data structure representing one or more supported body or hand tracking schemes.

Clause 59. The device of clause 58, wherein the enumerated facial expression schemes data structure comprises: typedef struct xrFacialExpressionScheme {XrStructureType type; const void* next; XrFacialSchemeType facialExpressionSchemeId; char schemeName[XR_MAX_SCHEME_NAME_SIZE]; const XrBool32 isNative;} XrFacialExpressionScheme.

Clause 60. The device of clause 58, wherein the enumerated skeleton schemes data structure comprises: typedef struct xrSkeletonScheme {XrStructureType type; const void* next; XrSkeletonSchemeType skeletonSchemeId; char schemeName[XR_MAX_SCHEME_NAME_SIZE]; const XrBool32 isNative; const uint32_t supportedJoints[XR_MAX_JOINT_COUNT];} XrSkeletonScheme.

Clause 61. The device of clause 57, wherein to create the tracking session, the processing system is configured to create a facial tracking session using a facial tracking function of the API.

Clause 62. The device of clause 61, wherein the facial tracking function comprises XrResult xrCreateFaceTracker (XrSession session, const XrFaceTrackerCreateInfo* createInfo, XrFaceTracker* faceTracker).

Clause 63. The device of clause 57, wherein to create the tracking session, the processing system is configured to create a body tracking session using a skeleton tracking function of the API.

Clause 64. The device of clause 63, wherein the skeleton tracking function of the API comprises XrResult xrCreateBodyTracker (XrSession session, const XrBodyTrackerCreateInfo* createInfo, XrBody Tracker* body Tracker).

Clause 65. A method of communicating augmented reality (AR) media data, the method comprising: establishing an augmented reality (AR) media communication session with a sending device; receiving data representative of one or more supported tracking schemes from the sending device; selecting one of the one or more supported tracking schemes to be used for the AR media communication session; sending data representing the selected one of the one or more supported tracking schemes to the sending device; receiving an animation stream representing tracking data conforming to the selected one of the one or more supported tracking schemes from the sending device; and animating an avatar of a user of the sending device using the animation stream.

Clause 66. The method of clause 65, wherein the one or more supported tracking schemes include one or more facial tracking schemes.

Clause 67. The method of clause 65, wherein the one or more supported tracking schemes include one or more body tracking schemes.

Clause 68. The method of clause 65, wherein the one or more supported tracking schemes include one or more hand tracking schemes.

Clause 69. The method of clause 65, wherein selecting the one of the one or more supported tracking schemes comprises selecting the one of the one or more supported tracking schemes based on animation capabilities.

Clause 70. The method of clause 65, further comprising retrieving data for the avatar from an avatar repository.

Clause 71. A device for communicating augmented reality (AR) media data, the device comprising: a memory configured to store AR media data; and a processing system implemented in circuitry and configured to: establish an augmented reality (AR) media communication session with a sending device; receive data representative of one or more supported tracking schemes from the sending device; select one of the one or more supported tracking schemes to be used for the AR media communication session; send data representing the selected one of the one or more supported tracking schemes to the sending device; receive an animation stream representing tracking data conforming to the selected one of the one or more supported tracking schemes from the sending device; and animate an avatar of a user of the sending device using the animation stream.

Clause 72. The device of clause 71, wherein the one or more supported tracking schemes include one or more facial tracking schemes, one or more hand tracking schemes, or one or more body tracking schemes.

Clause 73. The device of clause 71, wherein to select the one of the one or more supported tracking schemes, the processing system is configured to select the one of the one or more supported tracking schemes based on animation capabilities.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of communicating augmented reality (AR) media data, the method comprising:
invoking a function of an application programming interface (API) to determine one or more supported tracking schemes of an augmented reality (AR) runtime;
sending data representative of the one or more supported tracking schemes to a receiving device with which an AR media communication session is to be performed;
receiving, from the receiving device, data representative of a selected one of the one or more supported tracking schemes;
creating a tracking session with the AR runtime using the selected one of the one or more supported tracking schemes; and
sending an animation stream representing tracking information conforming to the selected one of the one or more supported tracking schemes to the receiving device.

2. The method of claim 1, wherein the one or more supported tracking schemes include one or more facial tracking schemes.

3. The method of claim 2, wherein invoking the function of the API to determine the one or more supported tracking schemes further comprises receiving data of an enumerated facial expression schemes data structure representing one or more supported facial tracking schemes.

4. The method of claim 3, wherein the enumerated facial expression schemes data structure comprises:
```
typedef struct xrFacialExpressionScheme {
  XrStructureType type;
  const void* next;
  XrFacialSchemeType facialExpressionSchemeId;
  char schemeName[XR_MAX_SCHEME_NAME_SIZE];
  const XrBool32 isNative;
} XrFacialExpressionScheme.
```

5. The method of claim 2, wherein creating the tracking session comprises creating a facial tracking session using a facial tracking function of the API.

6. The method of claim 5, wherein the facial tracking function comprises XrResult xrCreateFaceTracker (XrSession session, const XrFaceTrackerCreateInfo* createInfo, XrFaceTracker* faceTracker).

7. The method of claim 1, wherein the one or more supported tracking schemes include one or more hand tracking schemes.

8. The method of claim 1, wherein the one or more supported tracking schemes include one or more body tracking schemes.

9. The method of claim 8, wherein invoking the function of the API to determine the one or more supported tracking schemes further comprises receiving data of an enumerated skeleton scheme data structure representing one or more supported body or hand tracking schemes.

10. The method of claim 9, wherein the enumerated skeleton schemes data structure comprises:
```
typedef struct xrSkeletonScheme {
  XrStructureType type;
  const void* next;
  XrSkeletonSchemeType skeletonSchemeId;
  char schemeName[XR_MAX_SCHEME_NAME_SIZE];
  const XrBool32 isNative;
  const uint32_t supportedJoints[XR_MAX_JOINT_COUNT];
} XrSkeletonScheme.
```

11. The method of claim 9, wherein creating the tracking session comprises creating a body tracking session using a skeleton tracking function of the API.

12. The method of claim 11, wherein the skeleton tracking function of the API comprises XrResult xrCreateBodyTracker (XrSession session, const XrBodyTrackerCreateInfo* createInfo, XrBodyTracker* bodyTracker).

13. A device for communicating augmented reality (AR) media data, the device comprising:
a memory configured to store AR media data; and
a processing system implemented in circuitry and configured to:
invoke a function of an application programming interface (API) to determine one or more supported tracking schemes of an augmented reality (AR) runtime;
send data representative of the one or more supported tracking schemes to a receiving device with which an AR media communication session is to be performed;
receive, from the receiving device, data representative of a selected one of the one or more supported tracking schemes;
create a tracking session with the AR runtime using the selected one of the one or more supported tracking schemes; and
send an animation stream representing tracking information conforming to the selected one of the one or more supported tracking schemes to the receiving device.

14. The device of claim 13, wherein the one or more supported tracking schemes include one or more facial tracking schemes, one or more hand tracking schemes, or one or more body tracking schemes.

15. The device of claim 14, wherein to invoke the function of the API to determine the one or more supported tracking schemes, the processing system is further configured to receive data of at least one of an enumerated facial expression schemes data structure representing one or more supported facial tracking schemes or an enumerated skeleton scheme data structure representing one or more supported body or hand tracking schemes.

16. The device of claim 15, wherein the enumerated facial expression schemes data structure comprises:
```
typedef struct xrFacialExpressionScheme {
  XrStructureType type;
  const void* next;
  XrFacialSchemeType facialExpressionSchemeId;
  char schemeName[XR_MAX_SCHEME_NAME_SIZE];
  const XrBool32 isNative;
} XrFacialExpressionScheme.
```

17. The device of claim 15, wherein the enumerated skeleton schemes data structure comprises:
```
typedef struct xrSkeletonScheme {
  XrStructureType type;
  const void* next;
  XrSkeletonSchemeType skeletonSchemeId;
  char schemeName[XR_MAX_SCHEME_NAME_SIZE];
  const XrBool32 isNative;
  const uint32_t supportedJoints[XR_MAX_JOINT_COUNT];
} XrSkeletonScheme.
```

18. The device of claim 14, wherein to create the tracking session, the processing system is configured to create a facial tracking session using a facial tracking function of the API.

19. The device of claim 18, wherein the facial tracking function comprises XrResult xrCreateFaceTracker (XrSession session, const XrFaceTrackerCreateInfo* createInfo, XrFaceTracker* faceTracker).

20. The device of claim 14, wherein to create the tracking session, the processing system is configured to create a body tracking session using a skeleton tracking function of the API.

21. The device of claim 20, wherein the skeleton tracking function of the API comprises XrResult xrCreateBodyTracker (XrSession session, const XrBodyTrackerCreateInfo* createInfo, XrBodyTracker* bodyTracker).

22. A method of communicating augmented reality (AR) media data, the method comprising:
establishing an augmented reality (AR) media communication session with a sending device;
receiving data representative of one or more supported tracking schemes from the sending device;
selecting one of the one or more supported tracking schemes to be used for the AR media communication session;
sending data representing the selected one of the one or more supported tracking schemes to the sending device;
receiving an animation stream representing tracking data conforming to the selected one of the one or more supported tracking schemes from the sending device; and
animating an avatar of a user of the sending device using the animation stream.

23. The method of claim 22, wherein the one or more supported tracking schemes include one or more facial tracking schemes.

24. The method of claim 22, wherein the one or more supported tracking schemes include one or more body tracking schemes.

25. The method of claim 22, wherein the one or more supported tracking schemes include one or more hand tracking schemes.

26. The method of claim 22, wherein selecting the one of the one or more supported tracking schemes comprises selecting the one of the one or more supported tracking schemes based on animation capabilities.

27. The method of claim 22, further comprising retrieving data for the avatar from an avatar repository.

28. A device for communicating augmented reality (AR) media data, the device comprising:
a memory configured to store AR media data; and
a processing system implemented in circuitry and configured to:
establish an augmented reality (AR) media communication session with a sending device;
receive data representative of one or more supported tracking schemes from the sending device;
select one of the one or more supported tracking schemes to be used for the AR media communication session;
send data representing the selected one of the one or more supported tracking schemes to the sending device;
receive an animation stream representing tracking data conforming to the selected one of the one or more supported tracking schemes from the sending device; and
animate an avatar of a user of the sending device using the animation stream.

29. The device of claim 28, wherein the one or more supported tracking schemes include one or more facial tracking schemes, one or more hand tracking schemes, or one or more body tracking schemes.

30. The device of claim 28, wherein to select the one of the one or more supported tracking schemes, the processing system is configured to select the one of the one or more supported tracking schemes based on animation capabilities.
